(19) United States
(12) Patent Application Publication
(10) Pub. No.: US 2021/0315367 A1
(43) Pub. Date: Oct. 14, 2021

(54) SPILL-RESISTANT POUCH

(71) Applicant: TOUGHBUILT INDUSTRIES, INC., Lake Forest, CA (US)

(72) Inventors: MICHAEL H. PANOSIAN, IRVINE, CA (US); JOSHUA KEELER, LAKE FOREST, CA (US)

(73) Assignee: TOUGHBUILT INDUSTRIES, INC., Lake Forest, CA (US)

(21) Appl. No.: 16/846,608

(22) Filed: Apr. 13, 2020

(51) Int. Cl. A45F 5/02; B25H 3/00

(52) U.S. Cl. CPC A45F 5/021; A45F 2200/0575; B25H 3/006

(57) ABSTRACT

A spill-resistant pouch is attachable to a belt and has a pocket having spaced proximal and distal walls when worn on the belt of a user. The pocket has an upper opening for receiving objects within the pouch. The upper opening, when not subjected to loading stresses, normally defines a predetermined dimension extending between the proximal and distal walls, the pocket normally being deformable along the predetermined direction in response to forces applied by objects within the pocket on the distal wall. A rigidifying structure is provided within the pocket for substantially maintaining the predetermined dimension of the upper opening by preventing relative movements between the proximal and distal walls, whereby objects within the pocket are prevented from falling out through the upper opening due to excessive deformation of the distal wall relative to the proximal wall while providing unhindered access to items within the pouch.

### BACKGROUND OF THE INVENTION

### 1. Field of the Invention:

The present invention generally relates to tool bags or pouches and, more specifically, to a spill-resistant pouch for attachment to a belt.

### 2. Description of the Prior Art:

Tool bags or pouches typically supported on a belt for a worker may include one or a plurality of pockets for carrying tools or other objects used by a worker for installing, repairing and/or testing operations.

Such tool bags or pouches are typically formed of high Denier textile fabrics, such as nylon and polyester, that are at least partially deformable, particularly under the weight of heavier tools, such as hammers, that at least partially extend outside the pockets of the pouches or tool bags. Such larger and heavier tools can apply forces on the pouches that tend to deform them sometimes to the point of allowing a tool to fall out of the pocket.

An attempt to solve this problem is a tool bag disclosed in U.S. Pat. No. 9,826,819. In this patent, a main bag body has an upper opening and a space for receiving a flexible edge plate that forms an upward opening having a gap that gradually decreases from a middle portion towards two opposite ends of the middle portion. Two flexible sheets, essentially forming a funnel or one-way valve, are attached to the inner sides of the surfaces of the bag body to define an upper opening proximal to the upward opening and a lower bottom that is distal from the upward opening. The flexible edge plate defines a cross section smaller than the upper opening to prevent tools or other objects from falling out from the receiving space. The flexible sheets facilitate objects to be inserted into the bag and from falling out. The sheets, however, also make it more difficult to retrieve objects from the bag, especially smaller objects such as tape measures, small screwdrivers etc. that may be at the bottom of the bag or pouch, potentially causing injury to a user when lifting a tool past the narrow opening formed by the flexible sheets.

Other attempts have been made to prevent bags from sagging under the weight of tools and/or prevent tools from penetrating through walls of bags. In U.S. Pat. No. 6,435,304, for example, individual stiffening panels are mounted inside or outside walls of the bag, including the back wall and bottom wall. These individual, unconnected panels, which may be constructed of thin particle board, plywood or plastic sheeting, may prevent bulging or deformation of a particular wall but do not prevent relative movements or separation between the walls. Another approach to prevent sagging is to make the bags or pouches of high denier materials upward of 1000 D. While such heavier textiles are more rigid and help reduce the risk of wall separation and spill-out of contents such bags are heavier and more costly to manufacture.

### SUMMARY OF THE INVENTION

Accordingly, it is an object of the invention to provide a spill-resistant pouch that does not have the disadvantages of prior pouches or tool bags.

It is another object of the invention to provide an improved pouch that is simple in construction and economical to manufacture.

It is still another object of the invention to provide a spill-resistant pouch that is simple and convenient to use.

It is yet another object of the invention to provide a spill-resistant pouch in accordance with the previous objects that prevent potential injury to users who try to retrieve objects from the tool bag or pouch.

It is a further object of the invention to provide a spill-resistant pouch of the type under discussion that prevents tools or other objects from falling out of a pocket of a tool bag without hampering accessibility to tools or other objects contained therein.

It is still a further object of the invention to provide a spill-resistant pouch that prevents deformation and separation of proximal and distal walls of a pouch or bag with textile materials having a denier of less than 1000 D.

In order to achieve the above objects, as well as others that will become evident hereinafter, a spill-resistant pouch for attachment to a belt comprises attachment means for attachment to a belt. At least one pocket is secured to the attachment means and has an upper opening for receiving objects within the pocket. The upper opening normally has a predetermined dimension along a predetermined direction extending from a wall portion of the pocket proximal to the attachment means to a wall portion distal from the attachment means. The pocket is deformable along the predetermined direction in response to forces applied by objects within the pocket on the distal wall portion. A rigidifying structure within the at least one pocket is provided for substantially maintaining the predetermined distance of the upper opening by preventing relative movements between the proximal and distal wall portions. Objects within the at least one pocket are thus prevented from falling out through the upper opening by excessive separation between the distal and proximal wall portions while providing unhindered access to items within said pouch.

### BRIEF DESCRIPTION OF THE DRAWINGS

The above and other aspects, features and advantages of the present invention will be more apparent from the following description when taken in conjunction with the accompanying drawings, in which:

FIG. 1 is a side elevational view of a pouch or tool bag for attachment to a belt in accordance with to a prior art construction, indicating a tool on the verge of falling out of a pocket due to the deformation of the pockets and separation of distal and proximal wall portions resulting from the weight or forces applied by the contents, such as a hammer;

FIG. 2 is a side elevational view of a spill-resistant pouch in accordance with the present invention showing a plastic sheet placed within one of the pockets, the proximal pocket, to eliminate or substantially reduce the deformation and separation of the walls of the pockets to maintain a hammer in a substantially vertical orientation; and

FIG. 3 is a perspective view of the rigidifying structure shown in FIG. 2 in the proximal pocket of the tool bag or pouch.

### DETAILED DESCRIPTION

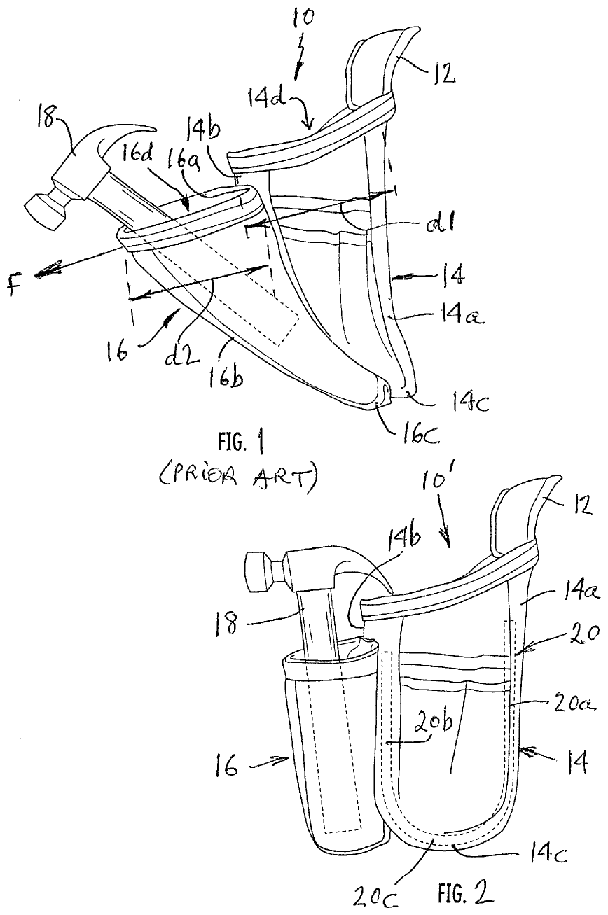

Referring now specifically to the figures, in which the identical or similar parts are designated by the same reference numerals throughout, and first referring to FIG. 1, a prior art tool bag or pouch 10 is illustrated that includes a belt loop 12 for attachment of the pouch 10 to a user's tool belt. Although a belt loop 12 is illustrated in FIG. 1, any suitable attachment means can be used for attaching the pouch or bag 10 to a user's belt.

The pouch or tool bag 10 includes a first pocket 14 that includes a rear wall portion 14a and front wall portion 14b, a bottom end or wall portion 14c and an opening 14d. The wall portion 14a is the proximal wall portion relative to the user when the pouch is worn on a tool belt while the wall 14b is a distal wall portion. The distance between the proximal and distal wall portions 14a, 14b at the opening 14d is “d1”. Secured to the pocket 14 is a second pocket 16 that similarly has a proximal wall portion 16a, a distal wall portion 16b, a bottom end or wall 16c and an upper open end 16d. Here, the distance between the proximal end distal wall portion 16a, 16b is “d2”. When a hammer 18 or other heavy tool applies a force F that force tends to stretch the walls of the pockets 14, 16 and increase the distances d1 and/or d2. Such deformation or stretching of the pockets in the direction of the force F tends to re-orient the tool 18 to a position that makes it more likely to fall out of the pocket 16, especially when a worker or user leans and rotates the bag or pouch 10 in a counter-clock wise direction, as viewed in FIG. 1.

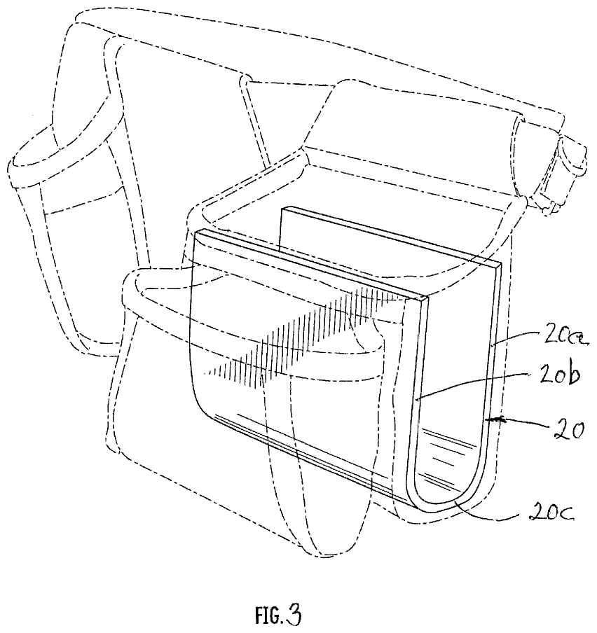

Referring to FIG. 2, an exemplary pouch in accordance with the invention is similar in configuration to the pouch shown in FIG. 1 but includes a rigidifying structure 20 in at least one of the pockets for substantially maintaining a predetermined distance d1 and/or d2 of the upper opening 14d and/or 16d by preventing relative movements between the proximal and distal wall portions 14a, 14b and/or 16a, 16b, respectively. In the presently preferred embodiment, the rigidifying structure 20 is formed of plastic and has a generally U-shaped cross section and includes two upright portions 20a, 20b that are spaced from each other as shown and bridged or connected at their lower ends by a bridging portion 20c. The upright portions 20a, 20b are substantially coextensive with the proximal and distal wall portions 14a. 14b and the bridging portion 14c is generally co-extensive with the bottom end or wall portion 14c. While the rigidifying structure 20 may exhibit some minimal flexibility it is essentially a rigid structure that substantially maintains the upright portions 20a, 20b at a fixed spacing.

As long as the proximal and distal wall portions 14a, 14b are prevented from moving relative to each other any suitable rigidifying structure can be used. In the presently preferred embodiment, the rigidifying structure 20 is in the nature of a generally flat panel having a substantially uniform U-shaped cross section as shown. By providing the rigidifying structure, for example, in the proximal pocket 14 the integrity of the distance d1 is maintained and this prevents amplification or compounding of the stretching or deformation, as suggested in FIG. 1.

While, in the prior art, as noted, walls of pouches have been provided with individual stiffening panels for different walls, these simply rigidify or stiffen individual walls of the pouch. However, the reinforcement of individual wall portions with stiffening panels does not prevent the movement of opposing wall portions resulting from the application of a force acting on one of these wall portions. With a U-shaped member or panel as shown in FIGS. 2 and 3 the distance d1 (and d2 if a similar stiffening member is utilized in the distal pouch 16) is maintained substantially constant notwithstanding the presence of forces F thereby maintaining the integrity of the pouch and helping to maintain tools in their upright positions. This prevents the overall shape of the pouch from excessively deteriorating, as suggested in FIG. 1, thereby minimizing or totally eliminating the possibility of tools easily falling out of the openings of the pockets of the pouch or tool bag.

While the invention has been shown and described with reference to certain embodiments thereof, it will be understood by those skilled in the art that various changes in form and detail may be made therein without departing from the spirit and scope of the invention as defined by the appended claims and their equivalents.

1. A spill-resistant tool pouch for attachment to a tool belt comprising attachment means for attachment to a tool belt; a first pocket secured to said attachment means and having an upper opening for receiving objects within said first pocket and an inner wall proximate to said attachment means and an outer wall distal to said attachment means, said upper opening normally having a predetermined dimension along a predetermined direction extending between said inner and outer walls, said first pocket being deformable along said predetermined direction in response to forces applied by objects within said first pocket on said distal wall portion; a second pocket secured to said outer wall and having an upper opening for receiving objects within said second pocket, said outer wall and said second pocket normally being oriented in a substantially vertical orientation when said pockets are unloaded or devoid of contents and worn by a user by means of said attachment means; and a rigidifying structure within said first pocket for maintaining said predetermined distance and maintaining said second pocket in said substantially vertical, whereby risk of spillage of tools from said second pocket is reduced.

2. A pouch as defined in claim 1, wherein said rigidifying structure is formed of a plastic material.

3. A pouch as defined in claim 1, wherein said first pocket has a bottom end below said upper opening and said rigidifying structure has a U-shape cross-section and includes two upright portions bridged or connected by a lower portion, said upright portions being coextensive with said proximal and distal wall portions and said lower portion is coextensive with said bottom end.

4. A pouch as defined in claim 1, wherein said rigidifying structure comprises a flat panel having a uniform U-shaped cross-section.

5. (canceled)

6. (canceled)

7. A pouch as defined in claim 1, wherein said attachment means comprises a belt loop for receiving a tool belt.

8. A pouch as defined in claim 1, wherein said pockets are formed of a textile material.

9. A pouch as defined in claim 8, wherein said textile is formed of nylon.

10. A pouch as defined in claim 8, wherein said textile is formed of polyester.

11. A pouch as defined in claim 8, wherein said textile has a denier less than 1000 D.

12. A pouch as defined in claim 1, wherein said second pocket is smaller than said first pocket.

13. A pouch as defined in claim 1, wherein said first pocket has a predetermined width and said rigidifying structure has a width equal to said predetermined width.

14. (canceled)
